(19) United States
(12) Patent Application Publication
(10) Pub. No.: US 2019/0291494 A1
(43) Pub. Date: Sep. 26, 2019

(54) STAMPING PRINTING PROCESS BY IMAGE TRANSFER WITH SPECIALLY COATED PAPER AND SUBLIMATION INK

(71) Applicants: Arides GARCIA DE LUNA, Rio de Janeiro RJ (BR); Matheus MALAFAIA LUNA, München (DE)

(72) Inventors: Arides GARCIA DE LUNA, Rio de Janeiro RJ (BR); Matheus MALAFAIA LUNA, München (DE)

(21) Appl. No.: 16/086,215

(22) PCT Filed: Feb. 13, 2017
(86) PCT No.: PCT/EP2017/053170

§ 371 Date: Feb. 12, 2019

(30) Foreign Application Priority Data
Mar. 18, 2016 (DE) 10 2016 105 134.9

(51) Int. Cl. B41M 5/52; D21H 19/54; D21H 19/64; B41M 5/382

(52) U.S. Cl. CPC B41M 5/5236; D21H 19/54; B41M 5/5218; B41M 5/382; D21H 19/64

(57) ABSTRACT

The present invention is a press-printing method for image transfer with a specially coated paper and sublimation ink, in which a pattern or image is printed on a paper coated with the special coating for subsequent transfer to the object to be printed. When used in an ink jet printing, screen printing, gravure printing or flexographic printing process, the coating prevents the printed ink from permeating the paper due to paper porosity. The image transfer from the coated paper to the object to be printed is performed by pressure and heat at a temperature between 200° C. and 230° C., wherein the coating is activated by the heat, so that the coating becomes soft and adjusts to the printing surface and is easily adhered to it. This allows a direct transfer of the sublimation ink to the contact area of the surface to be printed, which makes the coating superior to other coatings on the market.

### FIELD OF THE INVENTION

The present invention refers to a coating composition (coat) for use in a method for image transfer with sublimation ink, wherein, due to the properties of the coating composition (coat) for the used printing paper, it is possible to save costs and significantly improve the quality of the image or print pattern.

### DESCRIPTION OF THE PRIOR ART

The press printing method for image transfer on fabric has been known for some time. In this method, the image is preferably printed via printing processes, such as offset printing, gravure printing, flexographic printing, silkscreen printing or inkjet printing with sublimation ink on paper, from where it is transmitted by pressure and heating to the fabric.

The use of inkjet printers with sublimation ink has increased significantly over the past 15 years and has become more versatile. Therefore, it is currently possible to produce many different images even in smaller quantities, so that personalized images can be produced accordingly.

The thermo-sublimation printing technique is increasingly used for the heat-induced transfer of an image or pattern to synthetic fabrics and tableware, such as cups, plates, etc., as this technique enables a variety of applications for customer-specific imprints and significant cost savings for the product.

Regardless of the printing method with which the image or the pattern to be illustrated is transferred to the paper, the image transfer from the paper to the object with thermo-sublimation printing technique is predominantly applied to fabrics with synthetic surfaces, such as e.g. polyester fabrics, or porcelain and metal surfaces with polyester, polyurethane or similar surface coatings.

Synthetic fabrics, however, have the intrinsic property that at high temperatures in the range of, for example, between 200° C. and 220° C., and for longer press times, for example, in the range of 15 to 30 seconds, the material shrinkage is about 5%. However, this shrinkage varies, depending on the type of substance (warp and weft threads and material composition), from 3% to 10%. Since the image is transmitted to the fabric during the entire pressing time, the color sublimates gradually, also depending on the porosity of the fabric structure. While the sublimation paper does not shrink and the image retains its original dimensions, the fabric shrinks during the entire ink sublimation period. This can result in a reduction of the resolution and image quality on the fabric, or even a distortion of the image, which can cause setbacks in the working process and a high waste of printed fabrics. Depending on the image quality and sharpness requirements, the product specifications may also remain unfulfilled.

To avoid this problem, a method is often used in which the fabric is shrunk in advance (preshrinking). The material is pressed before the press printing process with the same pressure and temperature which are also applied in the actual press printing process. As a result, the fabric shrinks substantially even before the actual pressing with the paper, so that any remaining shrinkage, which can still occur in the ink sublimation step, does not impair the press printing process. However, the aforementioned preshrinking method may, in many cases, cause damage to the fabric, since it is subjected to two cycles of high temperature and a high pressure, wherein the first cycle is for the shrinkage and the second cycle for the image transfer. This may result in a flattening of the fabric threads and a burning (yellowing) of the tissue due to the high temperature. The fabric can thus lose some of its original properties, such as its texture, flexibility and brightness.

The paper, which is mainly used for image printing, is commonly used in everyday life also for conventional print processes because of its low costs. These are called “off set” or “bond papers” and weigh 70 g/m² or 90 g/m². Despite their wide distribution, these papers only allow prints in low resolution, with low-intensity colors and low contrast. In addition, the ink diffuses through the fibers of the paper to its back and leaves traces of color on the press. This results in a weak imprint on the substrate (fabrics, tableware, etc.) transmitted in the next hot transfer of the same image. To avoid this problem, it is necessary to separate the motif paper from the press by means of additional sheets of paper which absorb the continuous ink vapors. However, these paper sheets can be used only a few times and must be replaced regularly.

To solve this problem, coated papers with one or more coatings were developed, which are suitable for inkjet printing using sublimation ink, so that higher resolution, more intense and vivid colors and a higher contrast for the hot transfer on fabric, crockery and other surfaces can be achieved. As an example, it is referred to the papers according to the patent US 2008 229 962.

Accordingly, a coating (coat) of a paper consisting of one or more coating layers can comprise a sealing layer, so that the amount of ink vapor that penetrates the fibers of the paper is reduced. The sealing layer can prevent ink vapor from entering the back of the paper, eliminating the need to use an intercalating sheet.

The patent documents U.S. Pat. Nos. 6,902,779, 5,268,347, 4,997,807, 4,962,080 and U.S. Pat. No. 4,731,355 reveal various compositions that can be applied to a paper for this purpose.

Nowadays, white copy paper (off-set) is usually coated for the application described above, resulting in a paper with weights from 70 g/m² to 90 g/m². This paper is mainly made of short fiber cellulose and with a composition designed for good inkjet and laser printing quality. However, due to the properties described above, the paper has an undesirable porosity for use in ink jet printing with sublimation ink, which allows the ink vapor heated in the press to seep through the paper to the back.

### DISCLOSURE OF THE INVENTION

### Object of the Invention

It is therefore the object of the present invention to simplify the described press printing method, in particular to enable that the preshrinking step of a fabric to be printed is eliminated from the actual press printing process. In addition, a greatly improved image quality is to be achieved in the press printing process.

### Technical Solution

The solution for this task is a coated paper with the characteristics of claim 1 and a press printing method, in particular a thermo-sublimation printing method with the characteristics of claim 4. Advantageous embodiments are the subject matter of the dependent claims.

The present invention proposes to solve the aforementioned problems and disadvantages as well as tasks by using a coating specifically designed for application on paper with a surface weight equal to or greater 50g/m². The present invention proposes particularly a special coating for a paper for inkjet printing, gravure, flexographic or silkscreen printing with sublimation ink. Due to the inventive coating, various technical and economic advantages are provided compared to other coatings that are used for the same purpose.

On the one hand, the present invention provides a special coating for paper or a coated paper, which envelops the contours of the surface topography of an object to be printed, in particular fibers of a fabric structure, and is suitable for printing with sublimation ink, whereby the image to be printed first prints on the coated paper and then transfers from it to the object to be printed. The coating is suitable for use in ink jet printing, screen printing, flexographic printing and gravure printing process.

The invention also relates to a specially developed coating, which is fixed on the object to be printed by the heat and the residual moisture of the paper and the coating. The coating covers the surface structure to be printed, especially fibers of a fabric structure, so that an improvement of the image resolution can be achieved. Furthermore, due to the inventive special coating for the paper, the step of preshrinking an object to be printed can be eliminated, thus maintaining the original texture and flexibility of the object to be printed as well as its whiteness.

In addition, the invention ensures an increased fixation rate of the ink on the object to be printed and allows a significant increase in the light resistance of the print facing exposure of UV light and washing.

### BRIEF DESCRIPTION OF THE DRAWINGS

FIG. 1 shows the situation of the image transfer from a coated paper to the object to be printed with a coating according to prior art;

FIG. 2 shows the situation of the image transfer from a coated paper to the object to be printed with a coating according to the present invention.

### DETAILED DESCRIPTION OF THE INVENTION

In order that the invention may be better understood and evaluated, it is described in detail below. It should be noted, however, that the described embodiment of the invention can be altered or modified by a man skilled in the art without leaving the scope of protection of the present invention.

According to the present invention, a special paper coating is created to solve the above mentioned problems and to provide an improvement of the resolution of the image fixed to the substrate (especially for fabrics). The coating may have the following composition:
1. 93 to 98 wt. % modified corn dextrin, preferably about 96 wt. %,
2. 0.2 to 0.5 wt. % soda, preferably about 0.4 wt. %,
3. 1 to 3wt. % borax, preferably about 2 wt. %,
4. 1 to 2 wt. % sodium chloride, preferably about 1.6 wt. %.

The modified corn dextrin is a corn dextrin modified by starch, in particular pre-gelled starch. Especially, the modified corn dextrin may be a mixture of Vegecol 10A (trade name, Supplier: Polyamides—Brazil) and Penetrose 80 (trade name, Supplier: Ingredion Incorporated, Brazil), whereby the Vegecol 10A may be present in a quantity of 80 to 95 wt. % and the Penetrose 80 in a quantity of 5 to 20 wt. %.

The above-mentioned coating composition, with a viscosity between 3000 and 6000 CPs (Centipoise, where 1 CP=1 MPa s), is applied with a surface weight of 8 g/m² to 12 g/m² on a paper layer with a surface weight of 50 g/m² to 80 g/m². The residual moisture of the coating is in a range between 5 wt. % and 7 wt. %.

The coating of the paper can be done by applying the following procedures: painting, spraying, in particular with an air knife, gravure rollers or similar.

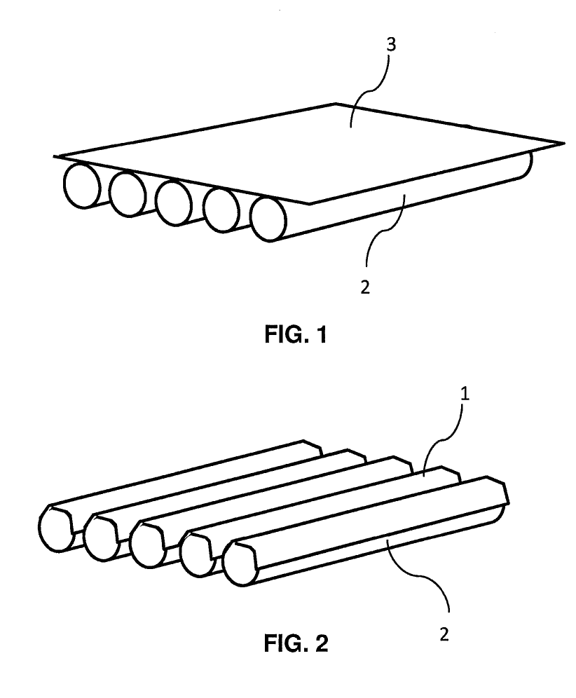

In the case of a continuous coating in a coating machine, the metering rate can be between 80 m/min and 100 m/min and the drying in an oven may be performed at a temperature between 100° C. and 120° C. Maintaining the residual moisture is of fundamental importance in this production process, since the residual moisture of the composition activates the coating when heated so that the coating 1 contour-faithfully covers the fibers 2 of the fabric (FIG. 2) and adheres to them so that the sublimation can take place direct contact and not only at the points of contact (FIG. 1), as currently with commercial coatings 3.

By applying this new coating to a paper, any image with sublimation ink can be printed on the coated paper through the aforementioned processes (ink jet printer, screen printing, flexographic printing and gravure printing process) and the sublimation ink applied on the coating 1 is fixed predominantly on the surface of the coating 1.

As advantages of the invention, the following aspects should be emphasized:
1°—Elimination of the preshrinking step of the fabric to be printed

The unique properties of the coating make it possible, when printing on a fabric, to utilize the heat in sublimation printing to vaporize the residual moisture in the paper and coating composition within fractions of a second. As a result, the coating 1 is activated so that it softens and adapts to the fabric structure 2 (FIG. 2) and surrounds the upper side of each fabric fiber 2 that is in contact with the coating 1. Then, the coating 1 is dried by the heat, so that it is easily adhered to the fabric. This adhesion is sufficient to stably hold an image or pattern on the fabric during the time that the sublimation and fixation of the ink on the fabric fibers 2 takes place. After pressing, the coated paper easily peels off the fabric without residue and can be removed.

This unique feature simplifies the production process to just one step and eliminates the need to preshrink the fabric. This allows great savings in production time and eliminates the full cycle of preshrinking, doubling production efficiency, reducing power consumption and cutting by almost half the wear on machinery.
2°—Increased printed image resolution

The unique characteristic of the coating, which ensures that each fiber 2 of the fabric in its middle contact area is surrounded with the coating 1, while in contrast to commercial coatings 3, the contact with the fabric fibers 1 is only tangential (FIG. 1), provides a significant improvement in image resolution, because the coating on the fabric fibers allows the positioning of the image in relation to the fabric to be maintained, so that the sublimation ink at each image point is transmitted in the same place of the fabric during the entire process duration.
3°—Increase of the fixation rate of the ink on the fabric fibers

The unique characteristic of the coating, which ensures that every face of the fabric in its middle contact area is surrounded with the coating, allows the ink to remain in direct contact with the fiber during the sublimation printing process. This increases the contact surface of the ink to the fabric fibers, which can increase the fixing speed of the sublimated ink on the fabric by 20%, without the ink being lost as steam due to the higher surface area of the coating with respect to the fabric threads. This means that the fabric printed with the coated paper shows more defined edges, contours and color gradients, higher color contrasts, a higher color depth and liveliness. Therefore, this new coating can be used to achieve a significant improvement in all visual aspects.
4°—Increased resistance to fading of the image or pattern by ultraviolet light (UV) or washing

Due to all the characteristics that the coating provides for the printed fabric, in particular by the larger ink fixing surface for the fabric fiber, a wider adhesion on the surface of the fabric fibers, a higher color throughout the fabric, a higher contrast, a higher liveliness and intensity of the colors and a higher image resolution, the light resistance of the pattern with respect to the effect of UV light is increased by at least 20%, as well as resistance to fading during washing.

Due to the special properties of the inventive coating for a printing paper, a fabric printed with this coat can provide a quality superior to the prior technique, both in terms of the visual perception of the pattern itself, as well as durability, print quality and wear resistance by the exposure to UV light, washing and its resistance to factors such as perspiration, friction, etc.

1. A coated paper for use in image transfer in a press printing process, wherein the coated paper has a paper layer and a coating with a composition of 93 wt. % to 98 wt. % corn dextrin, 0.2 wt. % to 0.5 wt. % soda, 1 wt. % to 3 wt. % borax and 1 wt. % to 2 wt. % sodium chloride, wherein the coating composition has a viscosity between 3000 and 6000 CP and is arranged in a layer with a surface weight of 8 g/m² to 12 g/m² on the paper layer, wherein the paper layer has a surface weight of 50 g/m² to 80 g/m² and residual moisture of the coating is in a range of 5 wt. % to 7 wt. %.

2. The coated paper according to claim 1, wherein the composition is 95.5 wt. % to 96.5 wt. % corn dextrin, 0.35 wt. % to 0.45 wt. % soda, 1.9 wt. % to 2.1 wt. % borax and 1.5 wt. % to 1.7 wt. %, sodium chloride.

3. The coated paper according to claim 1, wherein the corn dextrin is modified corn dextrin.

4. A press printing process for image transmission with the coated paper according to claim 1 and sublimation ink, wherein an image is applied on the coated paper through a printing process and the image is transferred from the coated paper to the object to be printed by the action of pressure and heat at a temperature of 200° C. to 230° C.

5. The press printing process according to claim 4, wherein the residual moisture in the coated paper and coating, when the image is printed on an object, is caused by the heat to evaporate in fractions of a second, so that the coating is activated in such a way that it becomes soft and adjusts to the structure of the object to be printed, thereby covering a surface of the object to be printed, which is in contact with the coating, wherein the coating is subsequently dried by the heat, so that it is easily attached to the surface of the object to be printed.

6. The press printing process according to claim 5, wherein the object to be printed has a fabric structure on the surface to be printed, so that, when the coating is activated and softens, it adjusts to the fabric structure, so that the top of each fabric fiber that is in contact with the coating is covered and the coating is fixed to the fabric so as to easily adjoin.

7. The press printing process according to claim 4, wherein any image or pattern with sublimation ink is applied to the coated paper using inkjet, silkscreen, gravure or flexographic printing, and stably fixed on the coating surface.

8. The press printing process according to claim 4, wherein due to the application of the coated paper in the press printing process, no preshrinking process of the object to be printed is carried out in the run-up to the image transfer.

9. The press printing process according to claim 6, wherein in the fabric structure, each fiber is at least partially enveloped with the coating during image transfer from the coated paper, so that the sublimation ink is in direct contact with the fibers, such that the printed fabric structure of the object to be printed presents defined edges, contours, color gradients and color contrasts.

10. The coated paper according to claim 1, wherein the composition is 96 wt. % corn dextrin, 0.4 wt. % soda, 2 wt. % borax and 1.6 wt. % sodium chloride.
